(19) United States
(12) Patent Application Publication
(10) Pub. No.: US 2008/0288131 A1
(43) Pub. Date: Nov. 20, 2008

(54) METHOD OF ENTRY AND EXIT OF A REMOTE CONTROL MODE OF A LOCOMOTIVE BRAKE SYSTEM

(75) Inventors: Kevin ROOT, Black River, NY (US); Richard J. Teifke, JR., Mexico, NY (US)

Correspondence Address: BARNES & THORNBURG LLP, 750-17TH STREET NW, SUITE 900, WASHINGTON, DC, 20006-4675, US

(73) Assignee: New York Air Brake, Watertown, NY (US)

(21) Appl. No.: 12/183,889

(22) Filed: Jul. 31, 2008

Related U.S. Application Data
(63) Continuation-in-part of application No. 11/531,891, filed on Sep. 14, 2006.

(51) Int. Cl. G06F 19/00

(52) U.S. Cl. 701/20

(57) ABSTRACT

A method of transitioning a locomotive brake control system between a remote operated locomotive RCL mode and an electronic air brake EAB mode includes initializing the system in the EAB mode; and determining a value of an RCL enable. Transitioning from the EAB mode to the RCL mode includes a) determining if the system is ready to be transitioned to the RCL mode if the RCL enable is high, and b) transitioning the system to the RCL mode if the system is ready for transition and the RCL enable is high. Transitioning from the RCL mode to the EAB mode includes a) determining if the system is ready to be transitioned to the EAB mode if the RCL enable is low, and b) transitioning the system to the EAB mode if the system is ready for the transition to the EAB mode and the RCL enable is low.

### CROSS REFERENCE

This application is a continuation-in-part of U.S. patent application Ser. No. 11/531,891 filed Sep. 14, 2006 and published as US 2008/0067866 A1 on Mar. 20, 2008, which is incorporated herein by reference.

### BACKGROUND AND SUMMARY OF THE INVENTION

The present invention relates generally to locomotive brake systems and remote controlled locomotives (RCL) and more specifically to entering and exiting a RCL mode.

One remote controlled locomotive or remote operated locomotive system usually includes a remote control transmitter (RCT) carried by an operator. In the industry, these are known as belt packs. Alternatively, there may be a console in the yard or a tower. The RCL systems are used to move a locomotive and the cars over a very short distance at a very low speed. It usually allows a remote operator not on the train to operate the system. The RCL systems control the propulsion and braking of the locomotives.

Another form of remote control of locomotives is communicating from a lead locomotive to remote trailing locomotives distributed throughout the train. The operator at the control of the lead mode locomotive sets the propulsion and braking at the lead locomotive, and appropriate signals are sent to the remote locomotives that are in trail mode to execute the required braking or propulsion. This may be the same braking or propulsion setting, or it may be a customized setting depending upon the location of the remote locomotive within the train. In this group of control over remote locomotives, the actual primary locomotive brake system is that which is being controlled. It controls not only the brake of the locomotive but may also operate on the brake pipe, which runs throughout the train.

Historically, RCL systems have used a standalone control of the propulsion and brakes on the train. This is in parallel to the standard locomotive control system. It has been suggested that the system used to control remote locomotives may also be adapted to use the primary brake system to be responsive to a portable remote control transmitter or belt pack. This requires appropriate interlocks and safety measures since it operates with the primary braking system. Such a system is shown in U.S. Pat. No. 6,964,456, which is incorporated herein by reference.

Present intelligent Electronic Air Brake (EAB) Systems developed for railroad locomotives are designed to interface with other subsystems as distributed power (DP) and electronically controlled pneumatic (ECP) train brakes. Such a system is shown in U.S. Pat. No. 6,334,654, which is incorporated herein by reference. An example is the CCB II system available from New York Air Brake. These integrations are subsystem specific as they are designed, and software written, that operate exclusive for that subsystem. Intelligent components of one EAB cannot be interchanged with that of another subsystem without compromising the functionality. This also is true with subsystems of like functionality but of differing OEM suppliers.

Remote Controlled Locomotive (RCL) subsystems available from different OEMs are of varying structures, interfaces and degrees of operability. Each OEM has their unique braking interface, be it pneumatically ‘serial’ or ‘parallel’ of the locomotive's braking system. Either configuration is reliant on the locomotive's core braking system. Typically, the RCL subsystem is the control of each power and braking for a railway vehicle, such as a locomotive. The RCL comprises on-board equipment that has a direct interface to the Electronic Air Brake (EAB) equipment as well as the power equipment and various feedback devices that are not within the confines of the EAB equipment. The on-board RCL subsystem may receive Operator commands remotely through an RF interface, tether cord and/or wayside equipment. The RCL may be completely without a human operator as commands are generated by distributed intelligence.

The present method of transitioning a locomotive brake control system between a remote operated locomotive RCL mode and an electronic air brake EAB mode includes initializing the system in the EAB mode; and determining a value of an RCL enable. Transitioning from the EAB mode to the RCL mode includes a) determining if the system is ready to be transitioned to the RCL mode if the RCL enable is high, and b) transitioning the system to the RCL mode if the system is ready for transition and the RCL enable is high. Transitioning from the RCL mode to the EAB mode includes a) determining if the system is ready to be transitioned to the EAB mode if the RCL enable is low, and b) transitioning the system to the EAB mode if the system is ready for the transition to the EAB mode and the RCL enable is low.

Determining if the system is ready to be transitioned includes determine if a brake pipe mode is a trail mode and if the brakes are applied. A braking signal is provided on a train brake pipe when the RCL enable is initially high and subsequently releasing signals are provided on the train brake pipe once the brake system is in the RCL mode.

Conditions of the locomotive brake system are monitored during receipt of the RCL enable and before setting the RCL mode and to maintain the RCL mode. The RCL enable is from a cut-in circuit for an RCL subsystem. The cut-in circuit may include a pressure sensor or a power switch for determining that the RCL subsystem has been cut-in.

The method further includes determining if an RCL heart beat signal has been received from a RCL. The transitioning from the EAB mode to the RCL mode then includes a) determining if the system is ready to be transitioned to the RCL mode if the RCL heart beat signal from an RCL subsystem has been received and the RCL enable is high, and b) transitioning the system to the RCL mode if the system is ready for transition, the RCL heart beat signal has been received and the RCL enable is high. The transitioning from the RCL mode to the EAB mode then includes a) determining if the system is safe to be transitioned to the EAB mode if the RCL heart beat signal has not been received or the RCL enable is low, and b) transitioning the system to the EAB mode if the system is safe for the transition to the EAB mode and the RCL enable is low.

A fault is set if the system is not safe for transition to the EAB mode and the RCL enable is low. The system sets an emergency in response to the fault. The fault is removed and the system is returned to the RCL mode if the RCL heart beat signal has been received, the RCL enable is high and the system is safe for transition to the RCL mode.

The determining if the system is ready to be transitioned to the RCL mode includes determining if the a brake pipe mode is a trail mode, and after the transition to the RCL mode, setting the brake pipe mode to error mode.

These and other aspects of the present invention will become apparent from the following detailed description of the invention, when considered in conjunction with accompanying drawings.

### BRIEF DESCRIPTION OF THE DRAWINGS

FIG. 1 is a schematic of a locomotive electric air brake system according to the present disclosure.

FIG. 2 is a logic diagram for entering and exiting the remote control locomotive mode according to a first embodiment.

FIG. 3 a logic diagram for entering and exiting the remote control locomotive mode according to a second embodiment.

### DETAILED DESCRIPTION OF THE PREFERRED EMBODIMENTS

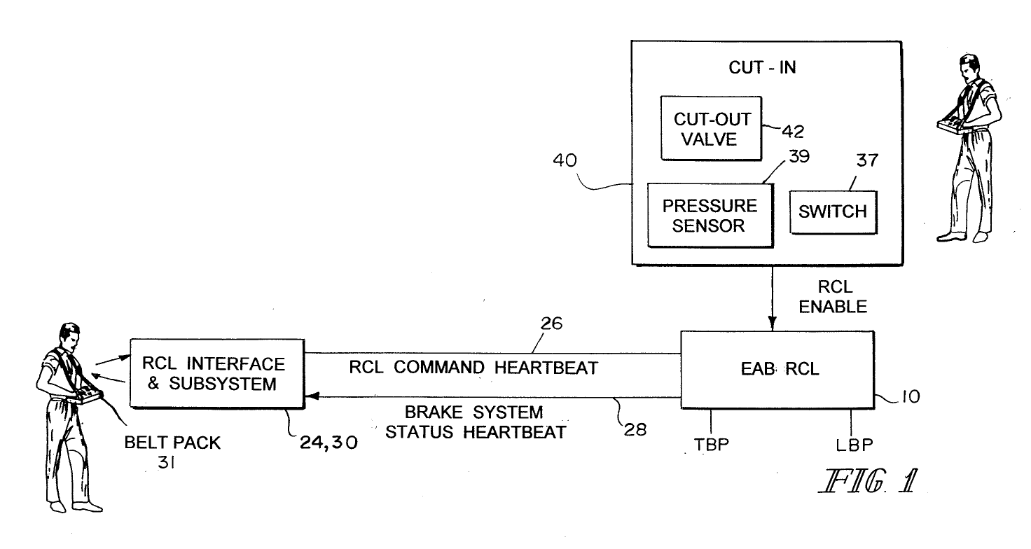

FIG. 1 show a known Electronic Air Brake (EAB) subsystem 10 consists of ‘intelligent controllers’ that are linked and share information or commands over an EAB network. As an example, a CCB II available from New York Air Brake and shown in U.S. Pat. No. 6,036,284 is incorporated herein by reference. There are five intelligent controllers depicted in FIG. 4 of the patent '284 as depicting a typical railway locomotive arrangement. The quantity and functional characteristics of intelligent controllers may and do vary between braking subsystem applications.

An operator inputs manual control commands for braking of a railway vehicle through the Operators Command Controller. The operator's commands are then communicated to the appropriate intelligent controller for the movement of compressed air for the application or release braking effort. For example, an Equalization Reservoir Controller responds to commands from the EAB network in response to operator input of the Operators Command Controller to electronically control a pressure level in an equalization reservoir. A Brake Pipe Controller is responsive to signals on the EAB network and the value of the pressure in the equalization reservoir to control the pressure in the train brake pipe TBP. The Equalization Reservoir Controller and the Brake Pipe Controller make available the pressure level status of the equalization reservoir and the train brake pipe respectively over the EAB network, to all the intelligent controllers.

An Independent Braking Controller responds to commands on the EAB network from the Operators Command Controller to electronically control a pressure level in a trainline or locomotive brake pipe LBP (commonly referred as Independent Application & Release Pipe). The Independent Braking Controller makes available the pressure level status of the locomotive pipe LBP, over the EAB network, to all the intelligent controllers.

The EAB network is the means of the EAB subsystem 10 to relay braking commands and status throughout the subsystem of intelligent controllers to provide operation of the railway vehicle's brakes. Also on the EAB network is a Vehicle Input/Output Interface Controller and a Communication Node or interface 24. The Communication Node 24 may be part of or in the Vehicle Input/Output Interface Controller. Other locomotive systems are connected to the EAB via the Vehicle Input/Output Interface Controller, such as Distributed Power, Electronically Controlled Pneumatic brakes, etc. One of these is shown as a Remote Controlled Locomotive (RCL) subsystem 30 which includes a belt pack or other remote controller transmitter 31.

Interface 24 of the EAB provides command messages and heartbeat 26 to the EAB network from the RCL subsystem 30. The EAB network provides status message and heartbeat 28 to the interface 24 for the RCL subsystem 30. Please note that this is a signal flow diagram and not a mechanical connection since they are interconnected and communicating to each other over the EAB network.

The RCL subsystem 30, as well as DP, ECP or any interface wanting the control of train or locomotive brakes, have two fundamental or primary needs from the EAB subsystem 10. Namely control of the brake pipe TBP through the equalizing reservoir pressure, and control of the locomotive's brake through the independent application & release pipe or locomotive brake pipe LBP as well as the actuating pipe (bail).

At the minimum, the core braking logic needs to respond to enforcement braking overriding that of the RCL. Emergency reductions have priority as break-in-two, Operator or Fireman. Safety equipment penalties, pneumatically activated on the EAB system are honored.

Part of the fundamental needs is communication of status information to signal the proper response of train brake and locomotive braking to the RCL subsystem 30. At the minimum this would include brake pipe and independent pipe pressures. It is the diversity between RCL of the various status or feedback signals required from the EAB subsystem to each unique control scheme(s) that defines their equipment.

An example of an combined EAB and RCL system and the details of the interconnection are shown in U.S. published application US 2008/0067866.

The RCL subsystem 30 is activated by a cut-in circuit 40. It may include a power switch 37 which provides electrical power to the RCL subsystem 30 or a cut-out valve 42 which provides pneumatic power for the RCL subsystem 30. A pressure sensor 39 provides an RCL enable signal to the EAB 10 when the cut-out valve 42 is opened. The status of the power switch 37 is monitored by the EAB 10 as an RCL enable signal.

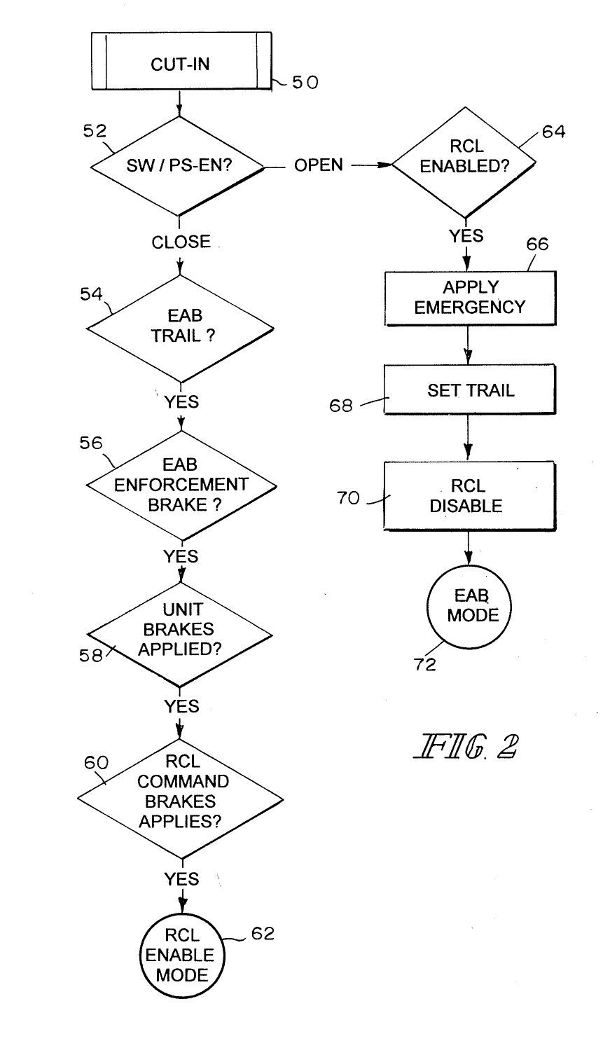

FIG. 2 describes the set-up conditions and required conditions to transfer states in response to the RCL enable from the cut-in circuit 40 of a first embodiment. The locomotive brake system is initialized in the EAB mode.

At Step 50, the cut-in circuit 40 is manually set to the cut-in mode. Next it is determined at Step 52 whether this has occurred by measuring the pressure on the locomotive brake pipe by sensor switch 49 or the position of the switch 37. If the pressure sensors switch 49 or the power switch 37 is closed, it is next determined at Step 54 whether the EAB system 10 is in the trail mode. If it is in the trail mode at Step 56, it is determined whether there is an EAB brake enforcement. If there is then at Step 58, it determines whether the locomotive or unit brakes are applied. If they are, it is determined at Step 60 whether the RCL command brakes are applied on the train brake pipe. If they are, the EAB system 10 under the control of the system control node sets the EAB system 10 to the RCL enable mode. This directs each of the EAB controllers to receive their controls from the RCL subsystem 30 instead of the operator's command controller.

At Step 52 if the pressure sensor 49 or power switch are open, it is determined at Step 64 whether the RCL is enabled. If it is, an emergency application is provided at Step 66 and the system is set to trail at Step 68. The RCL is disabled at Step 70 and the EAB system 10 enters the EAB mode at Step 72.

Note that an exit from RCL mode of operation is immediate and distinct on the loss of RCL enable input through an emergency brake application initiation by EAB 10. RCL 30 is not allowed to operate without the being cut-in.

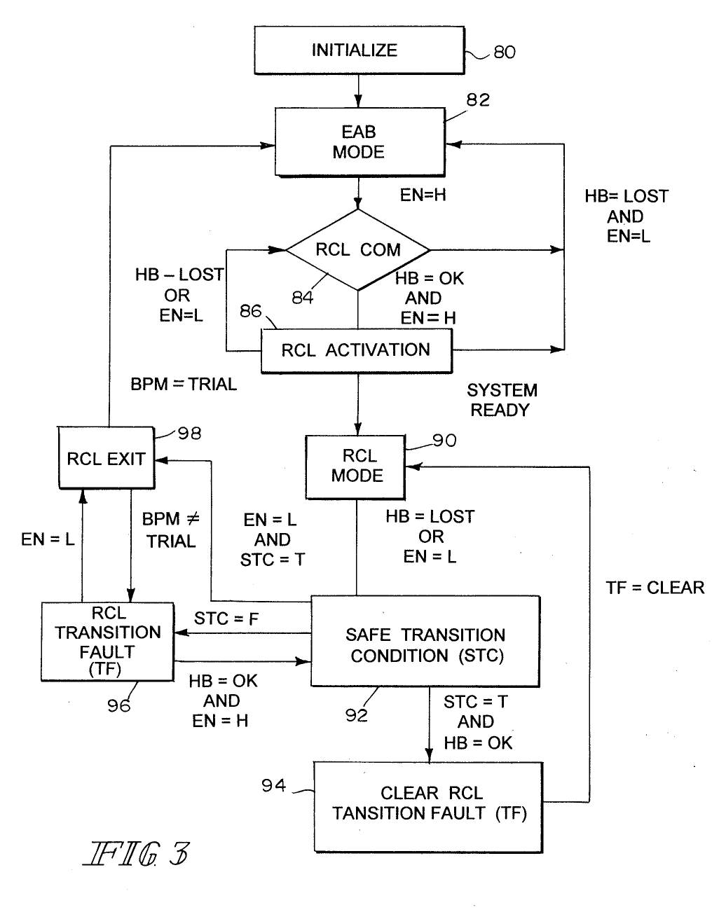

The second embodiment of entering and exiting RCL mode is illustrated in FIG. 3. The block generally represents a state and the required transition between states. This is generally performed by software. The locomotive brake system initializes at state 80 in the EAB mode state 82. It will only change from the EAB mode state 82 to the RCL mode state 90 when the RCL enable signal EN is high, the heartbeat HB is present, and the system is ready for the mode change. When the enable EN is high, the state is switched from the EAB mode state 82. The system stays in the EAB mode but the state is changed from the EAB mode state 82 to the RCL communication state 84. This is an awaiting state that looks for the combination of the RCL command heartbeat message HB to be ok and the RCL enable input EN to be high simultaneously. Thus, when the heartbeat HP is okay and the enable EN is high, the RCL activation state 86 is reached. If the enabled signal EN is low before a heartbeat HB is found, then the state will go RCL corn state 84 to EAB mode state 82.

In the RCL activation state 86, if the heartbeat is lost and the EN is low, the system returns to the EAB state 82. If while in the RCL mode activation state 86 either the heartbeat HB is lost, or the enable EN is low, the system cycles back to the RCL corn state 84 to wait for the occurrence of the heart beat HB being okay and the enable EN being high. The RCL activation state 86, determines whether the system is ready to transition to the RCL mode state 90. The system is ready for the transition when the brake pipe mode is the trail mode, there is no penalty or emergency status, the last locomotive brake pipe LBT command is above a given value indicating that the locomotive brakes LBP are to be applied and the last equalization reservoir command is below a given value indicating that the train brake pipe TBP has requested the cars apply their brakes.

Once the system has entered the RL mode state 90, it stays there until there is a loss of heartbeat HB or the RCL enable EN is low. If either of these occurs, then a safe transition condition state 92 is entered. This is determining if the transition from the RCL mode to the EAB mode is not due to system error and improper usage. This state 92 verifies that the braking system is in a safe condition to exit the RCL mode. The safe transition condition STC includes the last locomotive brake pipe LBT command having a pressure indicating that the locomotive brakes are to be applied and the last equalization reservoir command has a pressure below a given value indicating that the train brake pipe TBP has a brake signal thereon. Also required is that the measured value of the LBP is above a given value indicating that the locomotive brakes are applied.

If the safe transition condition STC is true and the heartbeat HB is ultimately okay, the system waits at state 94 to see if a transition fault TF has been cleared. If the transition fault has been cleared at state 94 then it cycles back to the RCL mode state 90.

If it is determined at state 92 that safe transition condition STC is not safe, or STF is false, then it is transferred to the RCL transition fault state 96. The RCL transition fault state 96 will set the system to initiate an emergency by setting the fault emergency bit. The system will remain in the state until the enable signal EN is low or the heartbeat HB has been restored and the enable signal EN is high. If the heartbeat signal HB is okay and the enable signal EN is high, then it transitions back to the safe transition condition state 92 for further processing through the clear RCL transition fault state 94 and back to the RCL mode state 90.

If the safe transition condition STC stays false and the enable EN goes low, the RCL transition fault state 96 transitions to the RCL exit state 98. The RCL exit state 98 can also be entered from the safe transition condition state 92. It is entered if the safe transition state STC is true and the RCL enable EN is low.

The RCL exit state 98 is the final state prior to entering the conventional EAB braking operation. This state is entered because the EAB system has either met the safe transition conditions STC or due to the request for emergency. It assumes that the system has met the safe transition conditions and also the RCL enable EN is a logic low. If the RCL enable is low and the safe transition conditions STC are true, then the RCL exit state 98 sets the brake pipe mode to trail and transfers to the EAB mode state 82. If this mode switches is not in the trail position, or a switch fault has occurred whereas the requested mode is not trail, then the RCL exit state 98 will transition back to the RL transition fault state 96.

Although the present invention has been described and illustrated in detail, it is to be clearly understood that this is done by way of illustration and example only and is not to be taken by way of limitation. The scope of the present invention is to be limited only by the terms of the appended claims.

What is claimed:

1. A method of transitioning a locomotive brake control system between a remote operated locomotive RCL mode and an electronic air brake EAB mode, the method comprising:
initializing the system in the EAB mode;
determining a value of an RCL enable;
transitioning from the EAB mode to the RCL mode includes a) determining if the system is ready to be transitioned to the RCL mode if the RCL enable is high, and b) transitioning the system to the RCL mode if the system is ready for transition and the RCL enable is high; and
transitioning from the RCL mode to the EAB mode includes a) determining if the system is ready to be transitioned to the EAB mode if the RCL enable is low, and b) transitioning the system to the EAB mode if the system is ready for the transition to the EAB mode and the RCL enable is low.

2. The method according to claim 1, wherein determining if the system is ready to be transitioned includes determine if a brake pipe mode is a trail mode and if the brakes are applied.

3. The method of claim 1, including providing a braking signal on a train brake pipe when the RCL enable is initially high and subsequently providing releasing signals on the train brake pipe once the brake system is in the RCL mode.

4. The method of claim 1, including monitoring conditions of the locomotive brake system during receipt of the RCL enable and before setting the RCL mode and to maintain the RCL mode.

5. The method of claim 1, wherein the RCL enable is from a cut-in circuit for an RCL subsystem.

6. The method of claim 5 wherein the cut-in circuit includes a pressure sensor for determining that the RCL subsystem has been cut-in.

7. The method of claim 5, wherein the cut-in circuit includes a power switch for determining that the RCL subsystem has been cut-in.

8. The method according to claim 1, further includes:
determining if an RCL heart beat signal has been received from a RCL;
transitioning from the EAB mode to the RCL mode includes a) determining if the system is ready to be transitioned to the RCL mode if the RCL heart beat signal from an RCL subsystem has been received and the RCL enable is high, and b) transitioning the system to the RCL mode if the system is ready for transition, the RCL heart beat signal has been received and the RCL enable is high; and
transitioning from the RCL mode to the EAB mode includes a) determining if the system is safe to be transitioned to the EAB mode if the RCL heart beat signal has not been received or the RCL enable is low, and b) transitioning the system to the EAB mode if the system is safe for the transition to the EAB mode and the RCL enable is low.

9. The method according to claim 8, including setting a fault if the system is not safe for transition to the EAB mode and the RCL enable is low, and the system sets an emergency in response to the fault.

10. The method according to claim 9, including removing the fault and returning to the RCL mode if the RCL heart beat signal has been received, the RCL enable is high and the system is safe for transition to the RCL mode.

11. The method according to claim 8, wherein determining if the system is ready to be transitioned to the RCL mode includes determining if the a brake pipe mode is a trail mode, and after the transition to the RCL mode, setting the brake pipe mode to error mode.

12. The method according to claim 11, wherein prior to transitioning from the RCL mode to the EAB mode, changing the brake pipe mode to the trail mode.

13. The method according to claim 12, if the brake pipe mode cannot be changed to the trail mode, setting a fault if the RCL enable is low, and the system sets an emergency in response to the fault.
